(19) United States
(12) Patent Application Publication
(10) Pub. No.: US 2025/0313144 A1
(43) Pub. Date: Oct. 9, 2025

(54) INTELLIGENT LIGHTBAR

(71) Applicant: ZENITH SECURITY SOLUTIONS LIMITED, London, Greater London (GB)

(72) Inventor: Russell HAMMAD, London (GB)

(21) Appl. No.: 18/869,995

(22) PCT Filed: May 31, 2023
(86) PCT No.: PCT/GB2023/051431

§ 371 Date: Nov. 27, 2024

(30) Foreign Application Priority Data
May 31, 2022 (GB) 2208012.1

(51) Int. Cl. B60Q 1/00; B60Q 1/26; B64C 39/02; B64U 10/14; B64U 20/50; B64U 50/19; B64U 50/38; B64U 70/93; B64U 70/95; B64U 70/99; B64U 80/86; B64U 101/31; B64U 101/55

(52) U.S. Cl. CPC B60Q 1/0023; B60Q 1/2611; B64C 39/02; B64U 10/14; B64U 20/50; B64U 50/19; B64U 50/38; B64U 70/93; B64U 70/95; B64U 70/99; B64U 80/86; B64U 2101/31; B64U 2101/55

(57) ABSTRACT

A lightbar (100) for mounting to a vehicle (140) is provided. The lightbar (100) comprises one or more warning lights (106), a compartment (126) configured to receive a drone (128), the compartment (126) being located within the lightbar (100), and at least one door (102) configured to move between a closed position in which the compartment (126) is in a closed state, and an open position in which the compartment (126) is in an open state, the movement of the door (102) to the open position enabling the drone (128) received in the compartment (126) to exit the compartment. A system (200) comprising the lightbar (100) and the drone (128), and a vehicle (140) are also provided.

### TECHNICAL FIELD

The present invention relates to a lightbar. More particularly, the invention relates to an intelligent lightbar configured to be mounted to a vehicle.

### BACKGROUND

Emergency services vehicles are generally fitted with warning lighting which, when activated, alerts the drivers of other vehicles, as well as cyclists, pedestrians and other road users to the presence of the vehicle. Often other road users are required to give way to the emergency vehicle, or to stop or pull over to allow the emergency vehicle to pass by, when the warning lights are activated. Emergency vehicles are known in which the warning lighting is mounted to the roof of the emergency vehicle. Mounting the warning lighting to the roof raises the profile of the lighting and increases the chance of other road users noticing that the warning lighting is activated. Therefore other road users are more effectively alerted to the presence of the emergency services vehicle.

Emergency services vehicles may also comprise a video camera or closed circuit television (CCTV) camera. The video camera may be used to record a driver's eye view from the dashboard of the emergency vehicle. In an example where the emergency services vehicle is a police car, such a video camera fitted to the police car may be used to record video evidence of potentially criminal activity happening in front of the police car.

Conventional warning lighting and video cameras for use on emergency vehicles are not intelligently designed and do not form part of an intelligent, integrated system.

Emergency services are increasingly using drones to collect data which it is not possible for a vehicle or personnel to collect. However, they are often required to travel within the vehicle, with no possibility for docking without human input.

We have appreciated that it would be desirable to provide an intelligent lightbar that has improved functionality, and is able to support the operation of a drone.

### SUMMARY OF THE INVENTION

The invention is defined in the independent claims to which reference should now be made. Advantageous features are set out in the dependent claims.

In a first aspect of the invention, there is provided a lightbar for mounting to a vehicle, the lightbar comprising one or more warning lights, a compartment configured to receive a drone, the compartment being located within the lightbar and at least one door configured to move between a closed position in which the compartment is in a closed state, and an open position in which the compartment is in an open state, the movement of the door to the open position enabling a drone received in the compartment to exit the compartment.

In one example the lightbar has a planar upper surface and the at least one door is configured to slide parallel to the planar surface of the lightbar.

In one example when the at least one door is in the closed position, the compartment is fully enclosed within the lightbar.

In one example the compartment comprises a moveable platform for receiving the drone, wherein the moveable platform can be moved from a first position in which the drone is fully received in the compartment, and a raised second position when the door is open.

In one example the compartment may include charging means to charge the drone.

In one example the charging means are one of a wireless charging coil or one or more contact pads.

In one example the charging means are located on the moveable platform.

In one example the lightbar further comprises an actuator to move the platform between the first and second position.

In one example the platform comprises a visual marking configured to be detected by a drone to aid the drone in landing.

In one example the lightbar may further comprise an actuator to move the at least one door between the closed position and the open position.

In one example the one or more warning lights face in one or more of a forward direction, back direction, and side direction.

In one example the lightbar further comprises one or more sensors, the one or more sensors include a digital camera, video camera, thermal imaging camera, LIDAR, and/or face recognition camera.

In one example when the lightbar is mounted on a vehicle, the one or more sensors is located between the one or more warning lights and the vehicle.

In one example the one or more sensors face in one or more of a forward direction, back direction, and side direction.

In one example the at least one of the sensors is a retractable sensor configured to move between a first and second position.

In one example in the first position the retractable sensor is enclosed within the lightbar, and in the second position the sensor is deployed such that a signal may be received by the sensor.

In one example any of the one or more sensors are operably connected to an in-camera AI processing chip to perform some functionality and/or are connected to a computer, wherein the in-camera AI processing chip and/or computer employ machine learning techniques to perform one or more of face recognition, number plate recognition and AI Deep learning processing.

In one example the lightbar further comprises one or more mounting elements to mount the lightbar to a vehicle.

In one example there is provide a drone for embedding within the lightbar, the drone comprising, one or more sensors and one or more batteries.

In one example the drone has contact pads configured to contact corresponding contact pads provided in the lightbar to charge the battery, or has means for wireless charging.

In one example the drone comprises one or more rotors mounted on folding arms such that the rotors and arms can be retracted to fit inside the compartment of the lightbar

In one example the drone is configured to autonomously avoid obstacles during flight and/or autonomously return to and dock on the platform of the lightbar.

In one example the one or more sensors comprises one or more cameras, and wherein the drone is configured to autonomously avoid obstacles during flight and/or autonomously return to and dock on the platform of the lightbar using computer vision based on images captured by the one or cameras.

In one example the one or more sensors are at least one of: a digital camera, a video camera, a thermal camera, a noise sensor, LIDAR or a smell sensor.

In one example the drone comprises connection means for wirelessly connecting to a controller.

In one example, the lightbar comprises one or more solar panels.

In another aspect, there is provided a system comprising, a lightbar and a drone.

In one example the drone is configured to wirelessly transmit data to a terminal located remotely to the lightbar.

In one example the system comprises a terminal configured to receive image data transmitted by the drone.

In one example the terminal is a cellular network enabled device and the data is received from the drone over a cellular network.

In another aspect there is a provided a vehicle comprising a lightbar and/or a drone.

In one example the vehicle comprises a camera mounted on the vehicle, wherein the camera is separate to the lightbar and the drone.

In one example the camera is mounted on the vehicle such that it faces in the direction opposite to the vehicle's normal direction of travel.

In one example the vehicle comprises a user terminal configured to receive data from the drone.

### BRIEF DESCRIPTION OF THE DRAWINGS

Embodiments of the invention will now be described, by way of example only, and with reference to the accompanying drawings in which:

FIG. 1 illustrates a front view of a lightbar according to the present invention;

FIG. 2 illustrates a back view of a lightbar according to the present invention;

FIG. 3 illustrates a side view of a lightbar according to the present invention;

FIG. 4 illustrates a perspective view of a lightbar according to the present invention;

FIG. 5 a front view of a lightbar having a deployed retractable sensor according to the present invention;

FIG. 6 illustrates a perspective cross sectional view of a compartment within a lightbar according to the present invention;

FIG. 7 illustrates a perspective view of a lightbar receiving a drone according to the present invention;

FIG. 8 illustrates a perspective view of a lightbar receiving a drone according to the present invention;

FIG. 9 illustrates a perspective cross sectional view of a compartment within a lightbar according to the present invention;

FIG. 10 illustrates a perspective view of a lightbar according to the present invention mounted on a vehicle;

FIG. 11 illustrates a front view of a lightbar comprising a solar panel; and

FIG. 12 illustrates a perspective view of a system comprising the lightbar according to the present invention mounted on a vehicle.

### DETAILED DESCRIPTION OF EXAMPLE EMBODIMENTS

The present invention relates to a lightbar configured to receive a drone within a compartment enclosed by the lightbar. We have appreciated that a drone enables data to be collected which assists emergency personnel in emergency situations, such as providing a birds eye view of a scene, in tackling high rise fires, reaching hard to get locations, acting as a microphone in places a person cannot reach, gathering data for augmented reality terrain and physical world overlays. We have also appreciated that it would be advantageous to incorporate a drone into a lightbar, to save space whilst also providing means for docking and charging of a drone without human input. Embodiments of a lightbar will be described herein which enable a drone to be embedded within the lightbar.

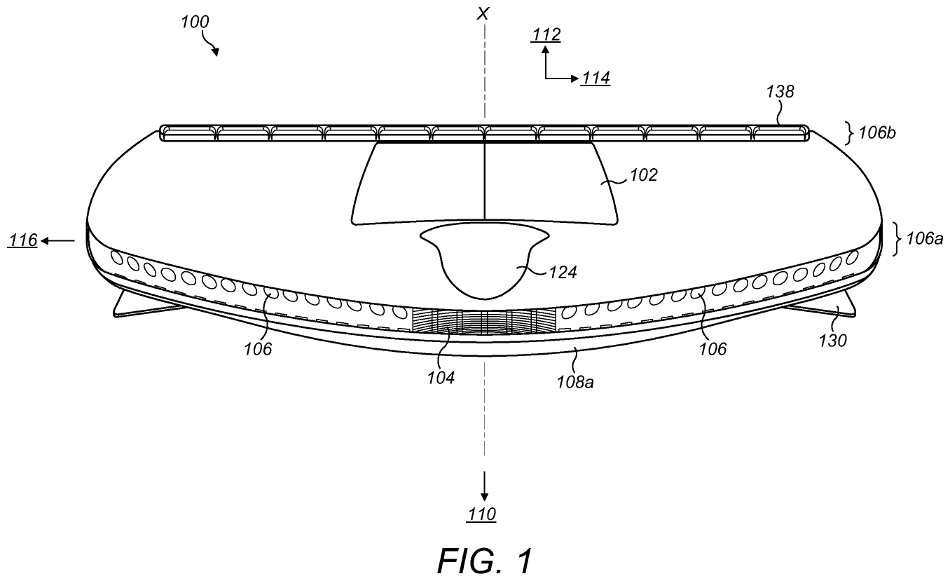

FIGS. 1 to 8 illustrate different perspective views of a lightbar according to an example of the present invention. In one embodiment, the lightbar 100 is mountable to the roof of a vehicle, such as an emergency services vehicle, including a police car or van, ambulance, or fire engine for example. The lightbar 100 may also be suitable for and mountable to any other vehicle, for example a non-emergency vehicle such as a school bus, lorry, rubbish truck, maintenance vehicle, or a road-mapping and imaging vehicle.

FIGS. 1 to 3 illustrate different perspective views of the lightbar 100, wherein the compartment is in a closed configuration.

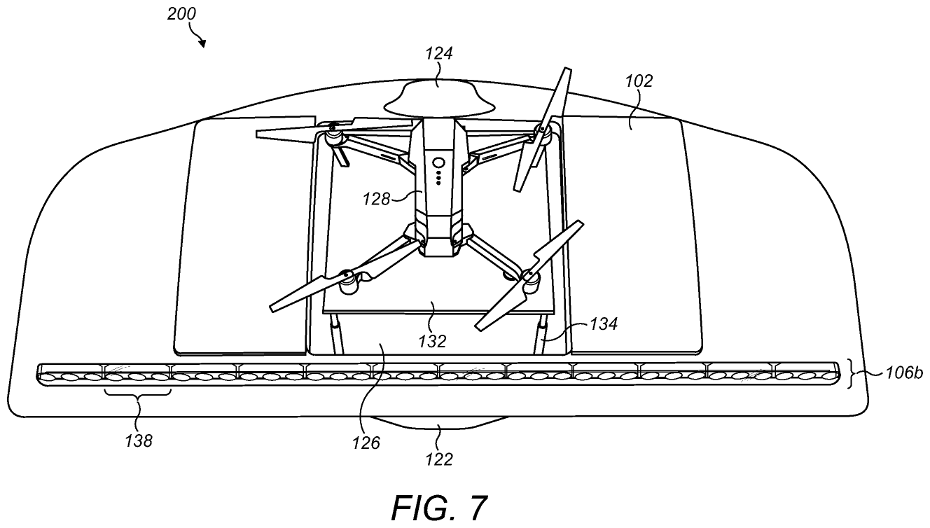

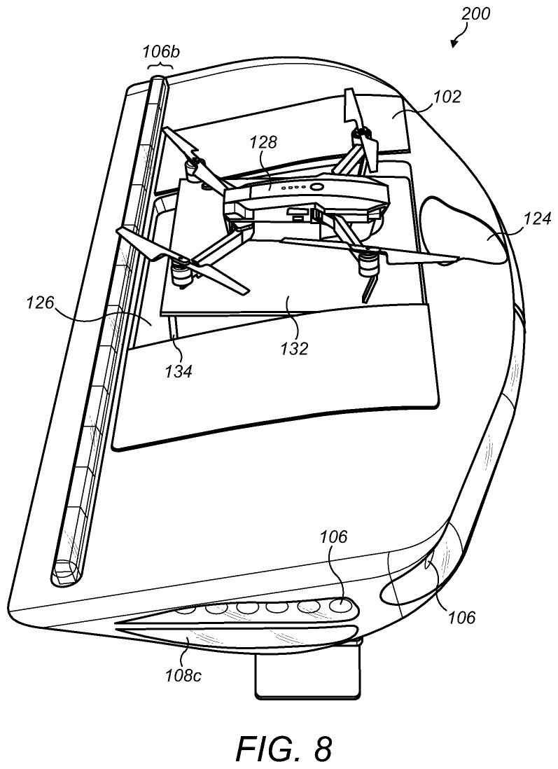

FIG. 1 shows a front view of the lightbar 100, according to an example of the present invention, comprising a plurality of warning lights 106, and a compartment configured to receive a drone. The lightbar also comprises a platform located within the compartment, which is configured to receive a drone. The platform and compartment will be illustrated and described in more detail in FIGS. 7 and 8 described herein. As shown in FIG. 1, the lightbar of this example comprises two sliding doors 102. The lightbar has a planar upper surface which faces away from the vehicle, and the doors slide parallel to the planar surface of the lightbar. Therefore, the doors slide parallel to the opening of the compartment. The doors are configured to move between a first, i.e. closed, position in which the compartment is in a closed state, as shown in FIG. 1, and a second, i.e. open, position in which the compartment is in an open state, as shown in FIGS. 7 and 8. When the doors are in the closed position the compartment is fully closed, and the doors form a water tight and dust tight seal with the upper surface of the lightbar, such that when the doors are closed, water and dust does not enter the compartment. In the closed position the compartment is fully enclosed within the lightbar, such that a drone embedded within the lightbar is fully enclosed within the lightbar when the doors are in the closed position. The compartment may have one or more locking mechanisms, such that a drone embedded in the lightbar may be locked, i.e. secured, in the compartment such that it cannot move inside the lightbar. The one or more locking mechanisms may be located on the platform such that a drone may be locked to the platform. Therefore the drone may be locked to the platform as it moves between a first and second position, and whilst it is embedded in the lightbar compartment. As shown in FIGS. 7 and 8, the doors slide in opposing directions, such that one door slides in a first sideways direction 116 and the other door slides in a second sideways direction 114 when the doors move between a closed and open position. The lightbar comprises an actuator, such as an electric motor, to move the doors between a closed and open position. The motor may be suitable motor such as a LEFS16E, LAT3 series or LEYG series motor. It is preferable that the actuator is not located within the compartment, such that it does not interfere with the receiving of a drone, as described later herein. It will be appreciated that although this example comprises two doors, in some embodiments, there may be a single door, which is the size of the opening of the compartment, and is configured to slide parallel to the planar surface of the lightbar.

To assist in locating certain elements of the lightbar a forward direction 110 is defined relative to the direction a vehicle to which the lightbar 100 is mountable would normally drive. Such that the forward direction is in the direction that a bumper of the vehicle faces. A backward direction 112 is defined as parallel and opposite to the forward direction 110, i.e. in the direction of the rear of the vehicle. A first sideways direction (or driver's left direction) 114 is defined as perpendicular to the forward direction 100. A second sideways direction 116 (or driver's right direction) is defined as parallel and opposite to the first sideways direction 114.

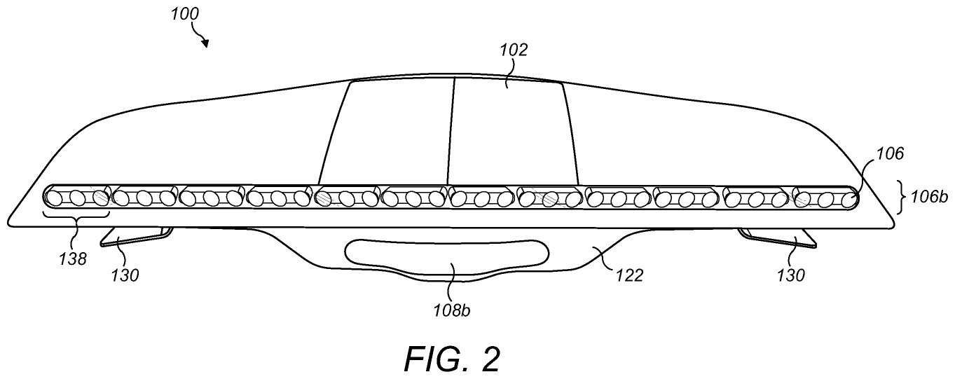

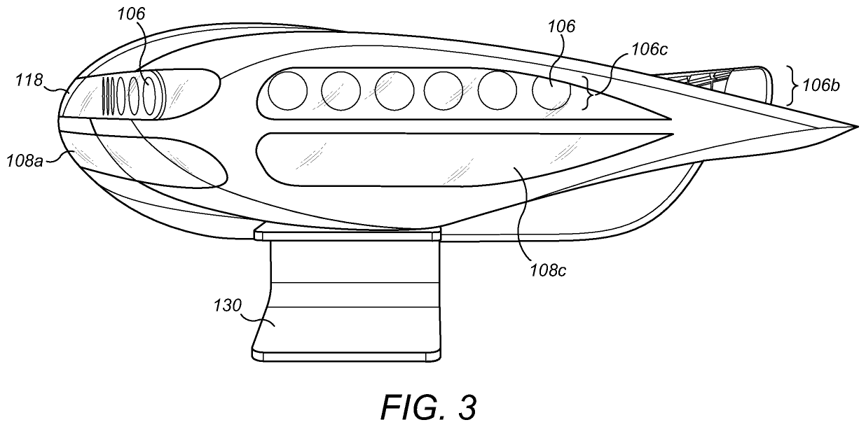

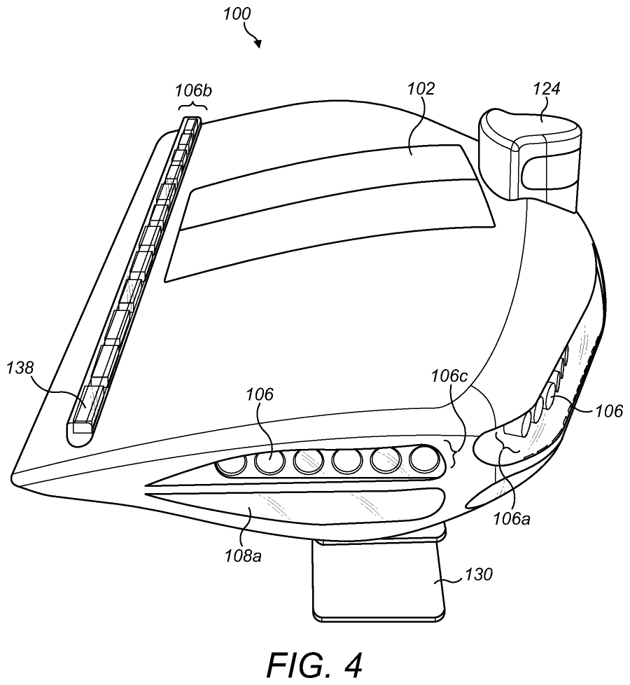

As shown, some of the plurality of warning lights 106 are arranged in a single row on the frontside of the lightbar 100, such that the set of warning lights 106a at the frontside of the lightbar face in a forward direction 110. In other embodiments, the lights may be arranged in multiple rows, such that the rows are located on top of each other. As shown in FIGS. 2, 3, and 4, the lightbar also comprises a set of warning lights 106b facing in the backwards direction 112, a set of warning lights 106c facing the first sideways direction 114 and a set of warning lights 106d facing the second sideways direction 116. As shown in FIGS. 2 and 4, the sets of warning lights 106a, 106b, 106c and 106d may be arranged in light banks 138 which comprise, for example, three lights 106. The set of lights 106a on the frontside of the lightbar and the set of lights 106b on the backside of the lightbar generally illuminate an area along the forward 110 and backward 112 directions respectively. The forward 106a and backward 106b facing sets of lights extend along a direction substantially parallel to one another. The sets of warning lights located on the side of the lightbar illuminate respective sideways directions 114, 116. Accordingly, the lightbar emits light from every or almost every direction around the lightbar, such that passers-by or occupants of vehicles located at all angles around the vehicle may see the lights. As shown in FIGS. 3, 4, and 5, the front facing, back facing, and side facing sets of lights are located closer to the upper surface of the lightbar than the lower surface of the light bar, which makes the warning lights 106 more visible during use. The lower surface of the lightbar is defined as the surface of the lightbar which faces the roof of a vehicle onto which the lightbar is mounted. As shown in FIGS. 3 and 4 the front facing 106a, back facing 106b, and side lights 106c and 106d are arranged in a discontinuous configuration, such that there are gaps between each of the sets 106a, 106b, 106c and 106d. However the warning lights are positioned and angled such that this does not greatly affect the visibility of the warning lights from any angle around the vehicle. For safety and for maximum visibility, arrangements are preferred in which at least one of the front facing, back facing or sideways facing warning lights is visible from any arbitrary azimuthal direction around the lightbar 100, and is visible from within a range of heights above and below the lightbar 100. In this example the lights are white LEDs. However, other lighting means are also possible, and incandescent lights, fluorescent lights or tubes, lasers or any other type of light generating device or light bulb, or any combination thereof, can be used. In the case where LEDs are used as the multiple of warning lights, each set of lights 106a, 106b, 106c and 106d can comprise an arbitrary number of LEDs according to the brightness and visibility desired. The use of a plurality of LEDs in each set of lights is preferable because it provides a level of redundancy. Thus, if one LED fails there are other LEDs present to ensure that the warning lights are still visible.

The lightbar of this example also comprises a light shielding cover 118 shown in FIG. 3. The light shielding cover 118 is formed of a material which protects the all of the warning lights 106 from water, dust, and other material but allows the light generated by warning lights 106 to shine outwards away from the lightbar 100. As mentioned earlier, and shown in FIG. 3, in this example there is a gap between the front facing 106a, back facing 106b, and side facing 106c and 106d sets of lights. Therefore each set of lights has a separate light shielding cover 118 which are not connected, as shown in the figures. In some embodiments the light shielding 141 comprises coloured glass or plastic and/or optical filters adapted to colour the light leaving the lightbar 100. The exact colouring applied can be chosen such that the warning lights conform to those used in the jurisdiction in which the lightbar is to be operated. Different parts of the lightbar 100 can comprise differently-coloured filters, for example such that half of the lightbar emits blue light and half emits red light. In alternative embodiments the shielding is substantially clear (uncoloured) and the light colouring is set by the warning lights themselves, for example by using coloured LEDs or lights with coloured bulbs. In all cases a high transparency of the light shielding cover 118 is desirable so as not to overly-attenuate the light leaving the lightbar 100. The light shielding 118 may also be arranged so as to optically modify the light leaving the lightbar 100, for example by focussing it towards one or more particular directions. For this purpose, the light shielding cover 118 of this example comprises a lens 104 located in front of a number of the warning lights. The lens is shown in FIGS. 1 and 3 as being located at the centre of the front face of the lightbar, such that it is situated in front of the warning lights located at the centre of the row of warning lights. For clarity, although not shown in FIGS. 1 and 3, the lens is located in front of warning lights, such that there are one or more lights located behind the lens, such that the lens is between one or more lights and a person viewing the warning lights. Thus the lens optically modify light from one or more of the lights 106 before it reaches a person viewing the warning lights from another vehicle, or from the ground. However, it will be noted that a lens 104 may also be located in front of at least some of the side facing, and/or back facing warning lights. The lens may be a Fresnel lens configured to concentrate light emitted from some of the warning lights, to enable the warning lights to be visible to persons located at large distances from the vehicle on which the light bar is mounted. In other embodiments, the lens 104 may be a diffuser lens which diffuses the light emitted from the warning lights located behind the lens. In these embodiments, the diffuser lens has the effect of diffusing the light emitted such that it may increase the spread of the light and make the warning lights more visible to a bystander or occupant of a car who is not directly in front of the lightbar.

The lightbar 100, according to an example of the present invention also comprises one or more sensors. One or more of these sensors may be one or more of front facing sensors 108a, back facing sensors 108b, and side facing sensors 108c and 108d. One of the one or more sensors is a retractable sensor 124 which is configured to move between a first and second position, wherein in the first position the retractable sensor is enclosed within the lightbar, and in the second position the retractable sensor is deployed such that a signal may be received by the retractable sensor.

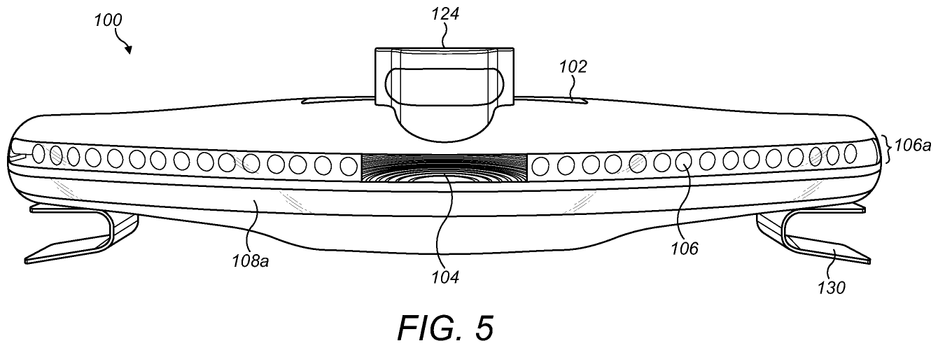

The front facing 108a, back facing 108b, and side facing 108c and 108d are shown in FIGS. 3 and 5 described herein. The set of one or more sensors may be digital cameras, video cameras, thermal cameras, or LiDAR (Light Detection and Ranging), or radar transmitters and receivers, or any combination of such sensors. In an embodiment in which the sensors are cameras, the cameras can be used for automatic number plate recognition (ANPR), face recognition, general surveillance around the lightbar 100, make model colour (MMC) analysis, crowd counting with behaviour analysis and activity classification, or any combination thereof. In an embodiment in which the sensors are thermal cameras, the thermal cameras may be used for detecting the presence of people or objects located in proximity to the vehicle on which the lightbar is mounted, but hidden, for example in a building or behind another vehicle. Although the sensors are front facing 108a, back facing 108b, and side facing 108c and 108d, the sensors may be able to move such that they are not limited to facing parallel or perpendicular to the vehicle. Instead, they may be able to move, for example to automatically follow a moving object, or move in response to a command from the occupant of the vehicle, or personnel on the ground, or in a central control room. In this way the sensors can provide a 360 degree view around the vehicle. In other embodiments, the sensors are not moveable. Instead the sensor data may be analysed by AI software, which is configured to detect various virtual regions or objects of interest. The regions or objects may be detected at various widths and heights within the field of view of the sensors. In the embodiment in which the sensor data is analysed by AI software, as an example, the one or more sensors may be one or more cameras. The one or more cameras may be used for ANPR and/or face detection and/or other analytics as listed above, wherein the AI is able to analyse the data received from the one or more cameras at both human height level and vehicle level. The one or more sensors may be operably connected to an in-camera AI processing chip, and/or to a processor and/or to a computer. The in-camera AI-processing chip, processor and/or computer may perform some functionality, such as automatic number plate recognition (ANPR), face recognition, general surveillance around the lightbar 100, make model colour (MMC) analysis, crowd counting with behaviour analysis and activity classification, or any combination thereof. The in-camera AI-processing chip and/or processor and/or computer may employ machine learning techniques to analyse the sensor data and perform the techniques mentioned herein.

The one or more sensors 108 are located closer to the roof of the vehicle to which the lightbar 100 is mounted than the multiple warning lights 106 on each of the front, back and two side faces, i.e., the one or more sensors 108 are located between the one or more warning lights and the vehicle onto which the lightbar is mounted. The location of the one or more sensors below the warning lights has the advantage that the one or more sensors are positioned at a more optimal height for capturing data, for example in an embodiment in which the sensors are digital cameras, the images of the faces of passers-by and people standing near the vehicle are more easily captured.

Although not shown here in the figures, the lightbar may include a processor and a memory, or a means to connect to a computer which may be operated in the vehicle. In such a way, the set of sensors may be connected to a computer with means for utilising the data to recognise faces, recognise number plates, count crowds, collect data on the make, model and colour of cars (MMC), or perform other data analysis. The computer may use machine learning techniques to identify, collect, store, and evaluate the collected sensor data including face characteristics, or letters and numbers of a possible number plate so that they can be matched to photos of people in a database, i.e., face recognition, or matched to number plates, i.e. ANPR (Automatic number-plate recognition). Such data analysis may determine when to deploy a drone embedded within the lightbar. An automatic number of plate recognition system analyses recorded images of vehicle number plates or registration plates obtained from the video camera(s). The system may perform optical character recognition (OCR) on the images to obtain the vehicle registration number, or the system may use AI deep learning techniques to recognise plate characteristics. The vehicle registration number can then be compared against a vehicle registration database to obtain information such as the vehicle owner, whether the vehicle has been properly registered with the authorities, and so on. As described, the video data collected by the one or more digital cameras on the lightbar may be used for face recognition. Such video data may be collected from at least one of the front, back or side facing sensors, or from the retractable sensor. The lightbar therefore can perform 360 degree face recognition based on one or more of these cameras. It will be appreciated that all of these cameras are at a suitable height to collect images of faces of passers-by, and such data may be compared to a database to identify a person, and the occupant of the vehicle, or personnel in a command centre or on the ground can act accordingly.

The lightbar also comprises a sensor shielding, which protects the front facing, back facing, and side facing sensors from water, dust or other material, without impeding the sensors functioning. As shown in FIGS. 2 and 3, the front facing, back facing, and side facing sensors have separate sensor shielding. The sensor shielding may be made from any suitable material, which may depend on the type of sensor located within the lightbar. For example, in an embodiment in which the sensor is a camera, the sensor shielding will allow light to enter the shielding at least at the regions of the shielding which are in front of the camera. In some embodiments, the shielding may be tinted or comprise an anti-reflection coating which allows light to enter the shielding from the outside but prevents light from passing from the sensor to the outside. One-way glass or a similar material may be used for this purpose. This prevents onlookers from seeing the one or more video cameras whilst still allowing the video cameras to capture images from outside of the lightbar 100. This may be beneficial, for example, if it is desired to avoid alerting people around the lightbar to the presence of the video cameras, and it helps to keep the locations of the video cameras hidden from view. In other embodiments, the sensor shielding is formed of a UV coated shaded polycarbonate, with the material in front of the camera lenses being formed of a clear polycarbonate.

As a further example, in an embodiment in which the sensors are thermal cameras, the shielding will allow infrared to enter the shielding at least at the regions of the shielding which are in front of the sensor.

FIG. 2 shows a back view of the lightbar 100, according to the same example of the present invention described in FIG. 1. As shown, the back facing warning lights 106b are located on the top surface of the lightbar 100. The back facing warning lights 106b are located away from the back edge of the lightbar, such that there is a section of exposed upper surface of the lightbar between the edge of the lightbar and the row of back facing warning lights. In this example, the back facing warning lights 106b do not extend to the side edges of the lightbar 100, such that there is a section of exposed upper surface of the lightbar between each end of the row of warning lights and the edge of the lightbar.

As will be shown in more detail in FIG. 3, in this example the upper surface of the lightbar is curved such that the majority of the back side of the lightbar has a smaller thickness than the front side of the lightbar. However, as shown in FIG. 2, at the centre of the back side of the lightbar, there is a protruding portion 122, which extends towards the roof of the vehicle on which the lightbar is mounted. The protruding portion 122 has a width and depth necessary to enable the back facing sensor 108b to be located on the protruding portion. It will be appreciated that in some embodiments in which there is no back facing sensor, the protruding portion may not be present, or in some embodiments in which there is a smaller/larger back facing sensor than in the present example, the protruding portion may be smaller. It will be appreciated that the lightbar is shaped to provide the best aerodynamics, and therefore it may be preferable to have as small a protruding portion as possible.

As shown in FIGS. 1 and 2, the doors 102 covering the compartment located within the lightbar extend from the row of back facing lights 106b towards the front of the lightbar. In this example the doors do not extend to the front facing row of lights 106a, leaving a portion of the upper surface of the lightbar between the doors and the front facing lights 106a, where the retractable sensor is located. The doors 102 are located on a portion of the upper surface of the lightbar which is substantially flat. As shown in FIGS. 1 and 4, the retractable sensor is located on a portion of the upper surface of the lightbar which is curved. At the front of the lightbar, the upper surface curves downwards towards the front edge of the lightbar.

FIG. 3 shows a side view of the lightbar. As shown in FIG. 3, although in this example, the front facing warning lights 106a are arranged in a straight row, the light shielding cover 118 is curved, such that the front face of the lightbar is curved in front of the row of warning lights. As also shown in the figure, the sensor shielding is also curved in front of the front facing sensors 108a. As shown in FIG. 3, the lightbar has a teardrop shape, such that the front face of the lightbar is rounded, and the upper surface curves downwards towards the back of the lightbar, whilst the lower surface curves upwards towards the back of the lightbar, such that the lightbar has a smaller thickness at the back face than the front face. However, it will be appreciated that other shapes of lightbar are possible.

FIGS. 3, 4, and 5 also shows mounting elements for mounting the lightbar to the roof of the vehicle. The lightbar 100 of the example embodiment is mounted to a vehicle by two mounting elements 130, one on the right side of the lightbar when facing the direction of driving, and one on the left side of the lightbar. The mounting elements 130 are attached to the lightbar 100, for example via screws. The mounting elements 130 are also screwed or fixed by any other suitable means to the roof of the vehicle. The mounting elements may be integral with the lower cover surface of the lightbar 100. As shown in more detail in FIG. 5, the mounting elements 130 of this example are curved, to form a ‘U’ shape turned 90 degrees, such that the two long sides of the mounting element are fixed to the lightbar and to the vehicle. However, it will be appreciated that the mounting elements may instead be straight rectangular elements which are perpendicular to the surface of the roof of the vehicle and attached to the lightbar and vehicle at each end. Alternatively, in other embodiments there may be one single mounting element located at the centre of the lightbar, which may be any size or shape sufficient for fixing the lightbar to the vehicle. The mounting elements are formed from any suitable strong material to ensure the lightbar is securely mounted to the vehicle.

FIGS. 4 and 5 illustrate the same lightbar 100 as described in FIGS. 1 to 3, where the retractable sensor 124 is in a deployed position. FIG. 4 shows a side view of the lightbar 100, and FIG. 5 shows a front view of the lightbar 100. When the retractable sensor is deployed, it extends from a first position, shown in FIGS. 1 to 3, to a second position, shown in FIGS. 4 and 5. In the first position the top surface of the retractable sensor is substantially in line with the upper surface of the lightbar adjacent to the retractable sensor. In the second, i.e., deployed, position, the retractable sensor is extended perpendicular to the surface of the lightbar, such that the retractable sensor faces in the forwards direction and is substantially level with the roof of the vehicle and therefor substantially level with the ground. The retractable sensor 124 is located in the middle of the width of the lightbar, such that it is centred over the centre of the vehicle on which it is mounted. As shown in FIG. 5, the retractable sensor 124 is hemispherical facing the front of the lightbar, with two side portions which also face the front of the lightbar. The retractable sensor may be a camera, or thermal camera, or LiDAR (Light Detection and Ranging), or radar transmitters and receivers, or any combination of such sensors. The retractable sensor may be a different sensor to any of the front facing, back facing, or side facing sensors 108. The retractable sensor may be deployed by a controller or may be automatically deployed based on data sensed by the set of sensors 108. As shown in FIG. 4, the retractable sensor 124 comprises a sensor shield to protect the retractable sensor. This may have any of the qualities described in relation to the other sensor shields described in relation to sensors 108. There may be more than one sensor located within the retractable sensor 124. The retractable sensor 124 may be able to rotate such that it may collect data over a larger range of angles around the vehicle. The retractable sensor provides the advantage of not being constantly deployed, such that it does impact the aerodynamics of the lightbar when not required to be collecting data. The retractable sensor is located at a higher position than the forward facing, back facing and side facing sensors 108a, 108b, 108c and 108d, which may provide the advantage of having an improved range of vision. Furthermore, the ability to retract the sensor 124 provides the advantage of the sensor being less likely to be damaged enabling a more high end sensor to be used with a decreased risk, as the sensor 124 is protected by being located within the lightbar 100 unless needed for specific applications. In an embodiment in which the retractable sensor comprises a LiDAR, the retractable sensor may be used for a variety of law enforcement applications, such as accurately measuring distances and speed of vehicles for speed enforcement.

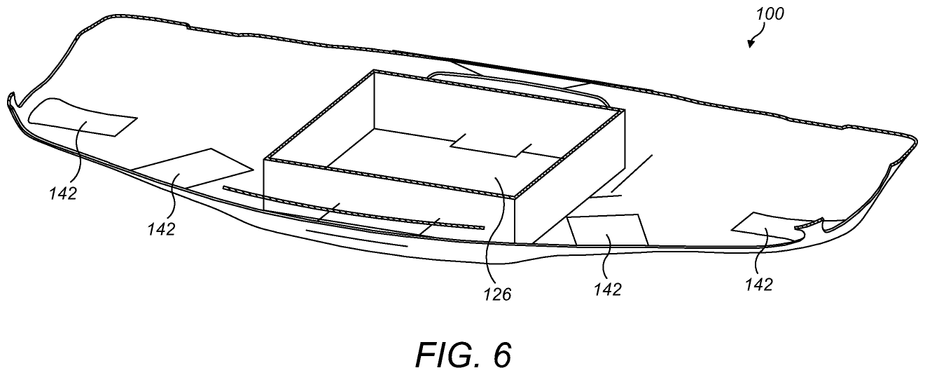

As mentioned earlier, the lightbar 100 comprises a compartment which is configured to receive a drone. FIGS. 6, 7 and 8 illustrate the compartment 126 of the example lightbar 100 described in relation to FIGS. 1 to 5.

FIG. 6 shows the compartment 126 located within the lightbar 100. As shown, the compartment may be a square shape, which is centred at the centre of the lightbar. Other shapes of compartment are possible, however, such as cylindrical. The compartment extends throughout substantially the entire height of the lightbar. The compartment does not extend the entire width of the lightbar, such that there is space on the left and right of the compartment. The motors, communication systems, electrical systems, or other systems are located in this space to the right or left of the compartment, as shown by example systems 142 in FIG. 6. Furthermore, although not shown, the compartment does not extend the entire length of the lightbar between the front and back surfaces, such that there is space on the front side of the lightbar to contain the retractable sensor 124 as described elsewhere herein. As described herein, the doors form a dust tight, water tight, and other material tight seal, to prevent damage to the inside of the lightbar when the doors are closed. The doors are configured to be closed except during take off or landing of the drone, in which case the doors are open, and the platform is moving between a first and second position, as described herein. As described herein, the platform may comprise one or more locking mechanisms such that the drone may be locked to the platform when landed on the platform. It will be appreciated that the process of take off and landing is as efficient as possible, such that the doors are open for as little time as possible, and therefore the compartment is exposed to the elements for as short a time as possible. However, we have appreciated that the deployment of the drone can not be postponed due to rain, or other conditions, and therefore the doors may be open during heavy precipitation. Therefore, there is the possibility that moisture may enter the compartment. The compartment 126 is therefore watertight, and contains no electronics, such that if water enters the compartment, the possibility of water damage is reduced.

FIG. 7 shows a back view of the lightbar 100 receiving a drone 128, and FIG. 8 shows a side view of the lightbar 100 receiving a drone 128. As described herein, the lightbar comprises at least one door 102, in this example there are two doors, which covers the compartment. In this example, the doors 102 are sliding doors, such that they slide in the plane parallel to the upper surface of the lightbar 100. As shown, one door slides to the right side of the lightbar, and the other door slides to the left side of the lightbar. The sliding of the doors from a closed position to an open position creates an opening to the compartment 126, such that a drone is able to exit the compartment, or a drone is able to enter the compartment. The doors are preferably slidable such that they may be opened whilst the vehicle is moving, without creating excessive resistance to the movement of the car or creating a greater risk of the doors breaking due to resistance. The doors are opened and closed by an actuator, such an electric motor. In this example the motor used in the lightbar to open the left and right doors is one of a LEFS16E, LAT3 series or LEYG series motor. Although not illustrated, the doors 102 may have targets, such as visual markings, such that the drone may identify the vehicle, and autonomously fly in a programmed pattern in relation to the vehicle. The drone may be configured to use the one or more markings to centre itself in relation to the platform when landing. For example, the doors 102 may have markings on their upper surfaces, which are identifiable by one or more cameras on a corresponding drone. For example, the drone may follow a program to fly alongside the car, or in circles around a specific radius of the car, or another programmed pattern. It will be appreciated, that although the platform 132 as described herein has markings to enable a drone to land on the platform, these will not be visible when the doors 102 are in a closed state, and the platform 132 is fully enclosed by the lightbar.

The opening to the compartment, and the compartment within the lightbar are both rectangular in this example. The compartment and opening are sized such that they are configured to receive a drone. Therefore, it will be appreciated that the size of the compartment and opening may vary depending on the size of the drone which is intended to be embedded in the lightbar.

The doors 102 are configured to open and close in response to a command received from a controller, such as the occupant of the vehicle on which the lightbar is mounted, or from personnel on the ground external to the vehicle or in a headquarters. Such a command may be via SIM connectivity, Wi-Fi connectivity, Bluetooth connectivity, or wired connectivity. Therefore, the lightbar comprises a receiver and transceiver for sending and receiving communications.

The lightbar 100 of this example comprises a platform 132 for receiving a drone, the platform being located within the compartment 126. The platform is flat, and is square, although in other embodiments it may be any polygon with a sufficient area to receive a drone. The platform is supported by four legs 134 which are fixed to the platform in each of the corners of the platform, and which are also fixed to the bottom surface of the lightbar. The legs may be fixed to the lightbar by screws and may be fixed to the platform by screws, or the legs may be integral to the platform. The legs 134 are extendable between a first and second position, such that the platform is moveable between a first and second position The platform is moved between the first and second position by an actuator, for example a motor. The motor may be any suitable electric motor, such as a LEFS16E, LAT3 series or LEYG series motor. In the first position the platform is lowered such that the lightbar is configured to fully enclose a drone within the compartment 126, i.e. the drone is fully received in the compartment. In the first position, the doors 102 are able to be in a closed state, i.e. the doors are in the closed position, without being in contact with the top of the drone 128. Therefore, the compartment has a depth sufficient to contain the platform in a first position, and a drone. In the second position, the platform is raised, such that the legs 134 are extended, and the top of the platform is substantially in line with the upper surface of the lightbar. Therefore, the platform is in the second position when the doors are open. When the platform is in the second position, the lightbar is configured to receive a drone located substantially outside of the compartment, such that the drone may take off and fly away from the lightbar without initially needing to fly vertically upwards to leave the compartment. When the lightbar receives a command to deploy its embedded drone, the doors move between a first and second state, such that the compartment is open. The platform then moves between a first and second position, such that the drone is raised substantially out of the compartment, and thus the lightbar. The embedded drone then takes off. The platform then moves from its second position to its first position, and the doors move from the open position to the closed position, such that the compartment is fully enclosed within the lightbar, It will be appreciated that in some embodiments the doors close simultaneously to the platform lowering between its first position to its second position, or the doors and platform may move at different times, i.e. one after another.

When the lightbar receives a signal that the drone is approaching to land, the doors move from the closed position to the open position, such that the compartment opens. The platform then moves between a first position and a second position, such that the platform is in line with the upper surface of the lightbar. It will be appreciated that in some embodiments the doors and platform may move simultaneously, or one after another. The lightbar receives the drone on its platform, and the platform then moves from the first position to the second position. Once the platform is in its first position, and the drone is within the lightbar, the doors are able to move from their open position to their closed position. Therefore, the drone is fully enclosed by the lightbar.

The compartment further comprises a charging means to charge a docked drone 128. The charging means may be a contact pad, which when in contact with a contact pad of the drone 128 results in charging the drone. Alternatively, the charging means may be a wireless charging means, wherein the compartment creates a magnetic field, which when in close proximity to a charging coil in the drone, charges the battery of the drone. The wireless charging capability of a compartment and drone has the advantage that the drone does not need to land, and instead may fly alongside the vehicle and recharge. Furthermore, the wireless charging means may enable the drone to charge without being opening the doors 102, which is advantageous in weather conditions such as when it is raining, to avoid rain entering the lightbar which may cause water damage to the components of the lightbar. The charging means may be located on the moveable platform 132. For example, the platform may comprise contact pads, or a wireless coil. Furthermore, wireless charging means may be manufactured into the compartment, or platform, such that none of the wireless charging means is exposed to the environment. Therefore, if the compartment or platform is exposed to moisture the wireless charging means is protected. Therefore, the risk of short circuiting is reduced, if not eliminated.

Although not shown here, in some embodiments one or more photovoltaic cells or solar panels may be affixed to the upper surface of the lightbar, for example to generate electricity to power the lightbar 100. This electricity powers the warning lights, the sensors, the motors for the doors and the platform, as well as charging the drone. Alternatively or additionally the lightbar comprises one or more batteries to power the warning lights, the sensors, the motors for the doors and the platform, as well as charging the drone. In some embodiments, the one or more battery cells may be used as a back up option if the photovoltaic cells or solar panels have not generated sufficient power, for example if the vehicle has been inside for long periods of time. Alternatively or additionally to photovoltaic cells or solar panels and one or more battery cells, the lightbar and its features as described herein, may be powered by the vehicle on which the lightbar is fixed. This has the advantage that it ensures a steady supply of electricity when the vehicle, and thus the lightbar, is in use.

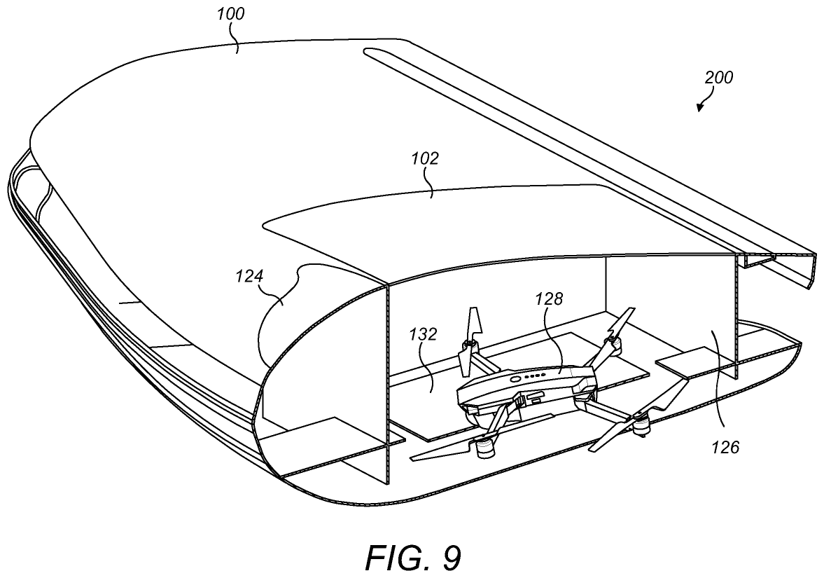

As described herein, and as shown in FIGS. 7, 8 and 9, a drone 128 is configured to be embedded in the lightbar 100. The drone is embedded in the lightbar when not deployed, as shown in FIG. 9, and when a command has been received, the drone is deployed. The drone is received on the platform of the lightbar. The opening of the doors 102 covering the compartment, the raising of the platform, and the take off of the drone may all be carried out by the receiving the same command. Alternatively, different commands may be received for each of the different functions. In this example the opening of the doors 102 prompts the raising of the platform to a second position, at which the majority of the drone is outside of the lightbar. From this position the drone is able to take off and fly away from the lightbar 100.

The drone 128 has one or more sensors which may be digital cameras, or video cameras, or thermal cameras, or LiDAR (Light Detection and Ranging), or radar transmitters and receivers, noise detection sensors, smell detection sensors, or any combination of such sensors. The sensors may be configured to be used for face recognition, ANPR, make model colour analysis (MMC), crowd counting with behaviour analysis and activity classification. The smell sensor is a sensor configured to detect odours by detecting the chemical composition of gases in the air surrounding the sensor. The smell detector may detect differences in concentration of chemical elements in air surrounding the sensor, which may enable the drone to locate the origin of a ‘smell’, such as a gas leak, or drugs, where the concentration of the specific chemicals in the air will increase with proximity to the drugs or gas leak. The noise detection sensor may comprise one or more microphones configured to detect noise, and analyse the volume of the noise, such that the sensor may enable the drone to locate the origin of the noise. The smell and noise sensors enable the drone to collect data which is not possible to be collected by the vehicle, as it will be appreciated that the drone is able to travel to areas more easily than a vehicle. The drone may analyse the data itself, or it may transmit collected data to security personnel on the ground, or at a central control room. The drone may transmit the data in real-time, or it may transmit data when a request for data is received. The sensor data, e.g. video data, is wirelessly transmitted to a terminal which is located remotely to the lightbar. The terminal may be a cellular network enabled device, where the data is received from the drone over a cellular network. For example the data from the drone may be transmitted to a mobile phone, or to smart glasses, or to a display in the vehicle on which the lightbar is mounted, or to a display in another vehicle, or to any other mobile device suitable to display sensor data, e.g. video data, to personnel on the ground. The sensor data is then able to be analysed by the personnel and provide information which neither the vehicle nor personnel would have been able to collect. The data may be analysed by the drone, or by an external computer before being transmitted to the mobile phone or smart glasses. The drone may be connected to the external device via SIM card connectivity, Wi-Fi, Bluetooth, or another connection means suitable to sending data.

In some embodiments the drone may be controlled by a controller, such as personnel on the ground, or an occupant of the vehicle on which the lightbar 100 is mounted, or a personnel in central control room. For example, a person or team in a central control room may control one or more drones. In one example, the person or team in a central control room may control a fleet of drones, in a fleet of emergency vehicles. This will enable a strategic and co-ordinated deployment of multiple drones in an emergency situation, without the requirement for the occupant of each vehicle to co-ordinate with occupants of individual other vehicles and personnel on the ground. Instead, the central control room may send a single command to multiple drones, or lightbars instructing them to deploy. In such embodiments the controller may control the drone, including landing/take-off and navigation of the drone in flight. In other embodiments, the drone is autonomous and requires no human input. In such an embodiment the drone utilises sensor data of the lightbar to deploy, and may use sensor data collected from either or both of the drone and lightbar for obstacle avoidance and smart return. For example, the drone may be configured to autonomously avoid obstacles during flight and/or autonomously return to and dock on the platform of the lightbar using computer vision based on images captured by the one or cameras.

Although not shown in the figures, the platform may comprise a target, such as a visual marking which enables the drone 128 to identify the lightbar 100 on which to land. The platform comprises a marking such that the drone can use its one or more cameras to locate the marking and land on the platform without human input. The marking may be a visible marking, such as a pattern which the drone may locate by the use of a camera on the drone. It is preferable for the marking on the platform to be unique such that the drone can recognise the correct vehicle to land on even if there are multiple vehicles with lightbars in the same area. It will be appreciated that this is advantageous if the lightbar is mounted on an emergency vehicle, which may be in a situation in which there may be a number of similar vehicles attending the same incident. As described elsewhere herein, the lightbar or platform may comprise other means for enabling the drone to locate the lightbar without human input. Using the marking on the platform and the video data received from the one or more cameras on the drone 128, the drone can automatically dock itself, referred herein as ‘smart return’. The drone may comprise or be connected to a computer capable of using AI (artificial intelligence) or machine learning techniques to analyse data received from one or more sensors on the drone, such as video data received from one or more cameras on the drone used to identify the marking. For example, computer vision may be used to accurately match the one or more symbols of the visual marking with a pattern stored on a database. Such analysis may improve the autonomous flying of the drone by improving identification of objects, such that the drone can better avoid obstacles. Such analysis may also improve the drone's accuracy for smart return, by being able to better identify the marking from other words or objects which may be in the video data collected by the camera on the drone. In some embodiments the drone may be an AI RoboDrone.

Alternatively or additionally the platform 132, or lightbar 100 may comprise a transmitter to emit a positioning signal which is received by a receiver on the drone, to provide the drone with a long range positioning signal. It will be appreciated that the visual marking on the platform is not capable of enabling the drone to ‘smart return’ when the platform and thus marking are out of visual range of the drone. Therefore signals may be emitted to enable the drone to locate the lightbar, and platform, from longer ranges. For example, the drone may have Global Navigation Satellite System (GNSS) receivers configured to compare the location of the drone to the vehicle/lightbar's location. In other examples, the drone may use WiFi or internet routers to determine its position relative to the lightbar. Such systems provide long range positioning of the drone, and when combined with the use of markers to provide close range positioning of the drone, the drone has an improved ‘smart return’ capability.

The drone 128 comprises one or more batteries, and also comprises a charging means such that it may re-charge from the platform 132. As described above the compartment, may comprise contact pads for charging and/or may comprise wireless charging means. In an embodiment in which the compartment comprises contact pads, the drone comprises such that the contact pads of the drone contact the contact pads of the compartment when docked. The contact pads may be located on the platform, such that the drone contacts the contact pads when received on the platform. In an embodiment in which the platform comprises wireless charging means the drone comprises a wireless charging coil, so that the drone wirelessly charges when in close proximity with the compartment. In some embodiments the wireless charging coil may be located in the platform such that the drone charges when in close proximity to the platform, i.e. received on the platform.

Additionally or alternatively the drone may be instructed to recharge in a remote fixed location prior to returning to the lightbar. In this example, the drone comprises one or more batteries and a charging means, as described above, such that it may charge from charging points other than the lightbar. For example, the drone may communicate to an operator that it is low on charge, such that the operator can navigate the drone to a remote fixed location at which there is a charging point. This enables the drone to perform longer journeys without having to return to the lightbar.

Additionally, the drone may be configured to charge in a lightbar which is not the lightbar from which it originally deployed. Therefore, the lightbar as described herein, may be configured to charge drones other than the drone originally embedded in the lightbar. Therefore, the charging means of each drone in a fleet of drones may be compatible with the charging means of each of the lightbars in a fleet of drones.

The drone 128 comprises one or more rotors which may be mounted on folding arms. As shown in FIGS. 7, 8 and 9, in this example the drone 128 has four arms, and four motors. The arms may be foldable such that the drone may decrease its size when it docks on the platform. This enables the compartment 124, and therefore the lightbar 100, to be smaller in size which may be advantageous, for example the lightbar may create less air resistance.

FIG. 9 shows a cross sectional view of a system 200 taken along line X shown in FIG. 1. The system 200 comprises a lightbar 100 and a drone 128, where the drone is embedded in the lightbar 100. As shown, the drone 128 is supported by a platform 132, which is located inside the lightbar 100. It will be appreciated that the figure is for illustrative purposes, and is not to scale. For example the drone may fill the majority of the compartment. As shown, when the platform is in a first position, the drone 128 is received on the platform, and fits inside the lightbar 100 enabling the doors 102 to be closed. Although not shown, it will be appreciated that the retractable sensor 124 is positioned such that it is separate to the compartment, and its movement between its first and second position does not interfere with the movement of the platform between its first and second position.

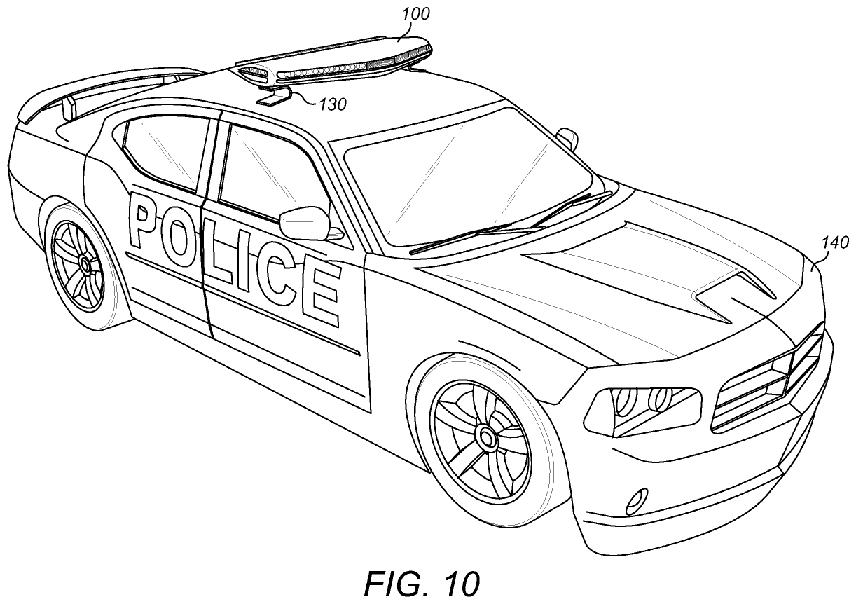

FIG. 10 illustrates the lightbar 100 as described herein mounted on to a vehicle 140. As shown, the mounting elements 130 are fixed to the roof of the vehicle 140. The lightbar 100 extends across substantially the entire width of the roof of the vehicle 140. The lightbar 100 is positioned relatively central on the roof of the vehicle, such that lightbar is fixed on the substantially flat portion of the roof. Therefore, the lightbar is substantially parallel to the ground on which the vehicle is driving, resulting in more accurate data, without requiring any calibration to take into account pitch and yaw of the car. However, it will appreciate that calibration methods may be utilised to improve data collected by the one or more sensors on the lightbar.

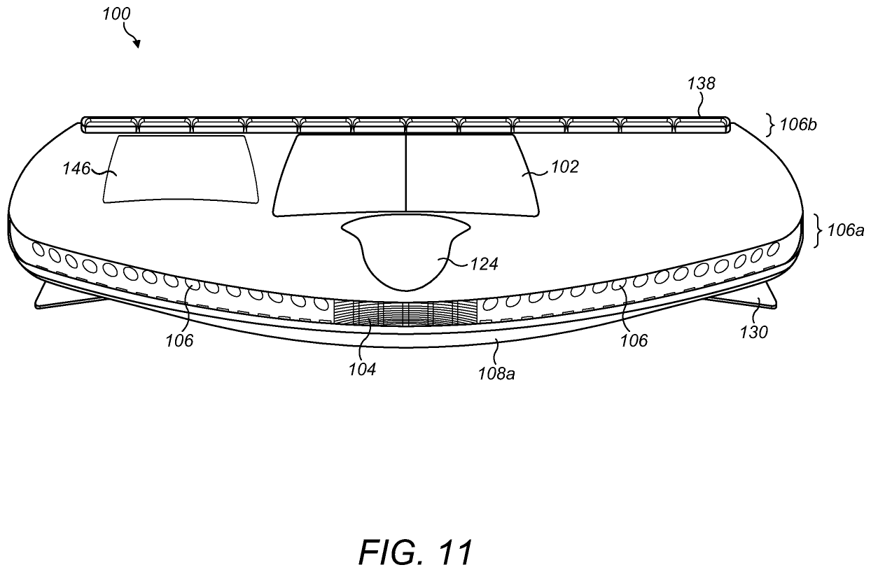

FIG. 11 illustrates a lightbar 100 according to the present invention including a solar panel 146. Lightbar 100 may comprise one or more solar panels 146, each solar panel comprising a plurality of photovoltaic cells. The one or more solar panels may be any suitable solar panels. The one or more solar panels are mounted on the lightbar, preferably on the upper surface of the lightbar, such that the one or more solar panels are exposed to sunlight. Although the solar panel 146 is illustrated as being mounted on the surface of the lightbar, the one or more solar panels may additionally or alternatively be mounted on the one or more doors 102. The one or more solar panels may be removable such that they are able to be detached, which may be preferable in periods of low light. In other examples, the one or more solar panels may be fixed such that they may not be removed by a user. It will be appreciated that the solar panel shown in FIG. 11 is for illustrative purposes, and the solar panel may be any suitable design. The solar panel shown is not to scale, and may be larger or smaller in comparison to the size of the lightbar. The one or more solar panels are configured to generate electricity from sunlight, and to provide this electricity to the lightbar. Such electricity may be utilised to power one or more of the sensors 108a, 108b, 108c, 108d and/or 124 as described in relation to FIGS. 1-10. Additionally or alternatively the electricity may be used to power the one or more doors 102, and/or to provide power to charge a drone via the contact pads or wireless charging coil, as described herein. The one or more solar panels are advantageous as it will be appreciated that the engine of the vehicle may not be running for long periods during which the drone may be deployed, or charging. Therefore, it is advantageous for the lightbar to be powered from a source which is external to the vehicle's battery. Therefore the lightbar may be configured such that the one or more solar panels power all or a subset of the features of the lightbar when the vehicle is stationary. However, the lightbar may also be configured to receive power from the battery of the vehicle when the vehicle is stationary if it has been determined that there is not sufficient power generated from the one or more solar panels to power all or a subset of the features of the lightbar.

Additionally, all or a subset of the features of the lightbar may be powered by the vehicle's battery when the vehicle is moving, and generating electricity. For example, the one or more warning lights 106 may be configured to be charged solely by the vehicle's battery as the one or more warning lights 106 are mostly used when the vehicle is moving. This therefore ensures that the vehicle provides sufficient electricity to the one or more emergency lights when the vehicle is moving. The lightbar may be configured such that the one or more warning lights 106 are solely powered by the vehicle, or the one or more warning lights may be powered by the vehicle whilst the vehicle is moving, and by the one or more solar panels whilst the vehicle is stationary. When the vehicle is stationary the one or more of the sensors 108a, 108b, 108c, 108, 124 and/or the one or more doors 102 may be solely powered by the one or more solar panels. Therefore the lightbar 100 may be a hybrid lightbar configured to be partially powered by the vehicle on which it is mounted and partially powered by one or more solar panels.

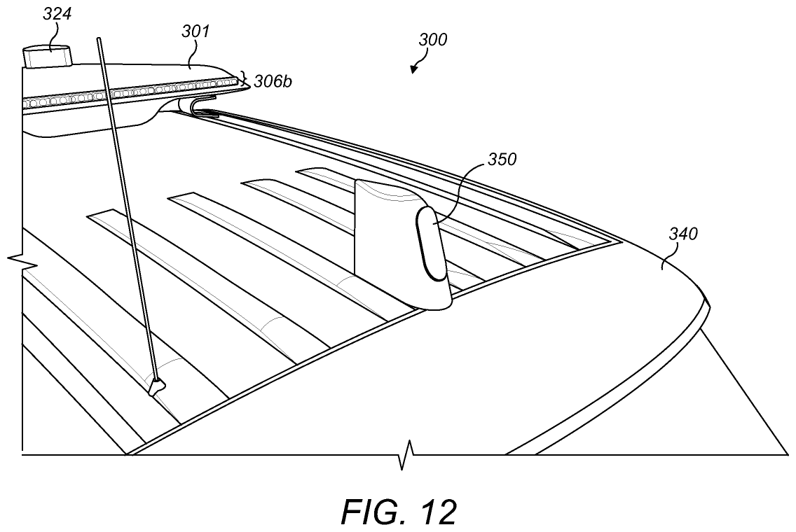

FIG. 12 shows a system 300 comprising a second example of a lightbar 301 according to the present invention. The lightbar 301 as shown in FIG. 12 is configured to be mounted on an SUV (sport utility vehicle), or a vehicle whose length is such that the back facing sensor 108b described in relation to lightbar 100 is not able to collect data from the back of the vehicle. For example, if the vehicle is a law enforcement SUV, lorry, or a fire engine, it has been appreciated that the back facing sensor 108b of the lightbar 100 would not be able to collect video data from behind the vehicle, or any video data collected would be too zoomed out, or of too low quality to be useful. Therefore, the lightbar 301 may be the lightbar 100 as described above, with any of the features described above, except that lightbar 301 may not comprise a back facing sensor. Additionally or alternatively to the back facing sensor of lightbar 100, the system 300 comprises a sensor 350, for example a camera, mounted on the rear towards the rear of the roof of the vehicle 340. As shown in FIG. 12 the sensor is mounted such that it faces in the direction opposite to the vehicle's normal direction of travel, i.e. it faces towards the back of the vehicle. The sensor does not face either side of the vehicle, as the lightbar comprises side facing and forward-facing sensors, as described in other embodiments herein. It is preferable for the sensor to be mounted on a substantially flat portion of the roof, whilst being as far back as possible, for reasons described earlier herein. The lightbar 301, as shown, comprises back facing warning lights 306b, as described in lightbar 100. As described in other embodiments herein, the vehicle may comprise a user terminal, configured to receive data from the drone deployed from the lightbar and/or data from the one or more sensors on the lightbar. This data may be displayed on a device mounted or integrated within the vehicle, or to a heads up display, or any other display within the vehicle which is able to be viewed by an occupant of the vehicle.

Various modifications to the example embodiments described above are possible and will occur to those skilled in the art without departing from the scope of the invention which is defined by the following claims. In particular, it should be understood that features described in relation to a single embodiment can be present in other embodiments.

1. A lightbar for mounting to a vehicle, the lightbar comprising:
one or more warning lights;
a compartment configured to receive a drone, the compartment being located within the lightbar; and
at least one door configured to move between a closed position in which the compartment is in a closed state, and an open position in which the compartment is in an open state, the movement of the door to the open position enabling a drone received in the compartment to exit the compartment.

2. The lightbar according to any preceding claim wherein the lightbar has a planar upper surface and the at least one door is configured to slide parallel to the planar surface of the lightbar.

3. The lightbar according to any preceding claim wherein when the at least one door is in the closed position, the compartment is fully enclosed within the lightbar.

4. The lightbar according to any preceding claim, wherein the compartment comprises a moveable platform for receiving the drone, wherein the moveable platform can be moved from a first position in which the drone is fully received in the compartment, and a raised second position when the door is open.

5. The lightbar according to claim 4 wherein the compartment includes charging means to charge the drone.

6. The lightbar according to claim 5, wherein the charging means are one of a wireless charging coil or one or more contact pads.

7. The lightbar according to claim 6, wherein the charging means are located on the moveable platform.

8. The lightbar according to any of claims 4 to 7 wherein the platform comprises a visual marking configured to be detected by a drone to aid the drone in landing.

9. The lightbar according to claim 1 further comprising an actuator to move the at least one door between the closed position and the open position.

10. The lightbar according to any preceding claim wherein the one or more warning lights face in one or more of a forward direction, back direction, and side direction.

11. The lightbar according to any preceding claim further comprising one or more sensors, the one or more sensors include a digital camera, video camera, thermal imaging camera, LIDAR, and/or face recognition camera.

12. The lightbar according to claim 11 wherein when the lightbar is mounted on a vehicle, the one or more sensors is located between the one or more warning lights and the vehicle.

13. The lightbar according to claim 11 or 12 wherein the one or more sensors face in one or more of a forward direction, back direction, and side direction.

14. The lightbar according to any of claims 12 to 13, wherein at least one of the sensors is a retractable sensor configured to move between a first and second position.

15. The lightbar according to claim 14 wherein in the first position the retractable sensor is enclosed within the lightbar, and in the second position the retractable sensor is deployed such that a signal may be received by the retractable sensor.

16. The lightbar according to claims 11 to 15 wherein any of the one or more sensors are operably connected to an in-camera AI processing chip to perform some functionality and/or are connected to a computer, wherein the in-camera AI processing chip and/or computer employ machine learning techniques to perform one or more of face recognition, number plate recognition, and AI Deep learning processing.

17. The lightbar according to any preceding claim further comprising one or more mounting elements to mount the lightbar to a vehicle.

18. A drone configured to be received within the lightbar of any of claims 1 to 17, the drone comprising:
one or more sensors; and
one or more batteries.

19. The drone according to claim 18, wherein the drone has contact pads configured to contact corresponding contact pads provided in the lightbar to charge the battery, or has means for wireless charging.

20. The drone according to claim 18 or 19, comprising one or more rotors mounted on folding arms such that the rotors and arms can be retracted to fit inside the compartment of the lightbar.

21. The drone according to claim any of claims 18 to 20, where the drone is configured to autonomously avoid obstacles during flight and/or autonomously return to and dock on the platform of the lightbar.

22. The drone according to any of claims 18 to 21 wherein the one or more sensors comprises one or more cameras, and wherein the drone is configured to autonomously avoid obstacles during flight and/or autonomously return to and dock on the platform of the lightbar using computer vision based on images captured by the one or cameras.

23. The drone according to any of claims 18 to 22 wherein the one or more sensors are at least one of: a digital camera, a video camera, a thermal camera, a noise sensor, LIDAR or a smell sensor.

24. A system, comprising:
a lightbar according to any of claims 1 to 17; and
a drone according to any of claims 18 to 23.

25. The system of claim 24, wherein the drone is configured to wirelessly transmit data to a terminal located remotely to the lightbar.

26. The system of claim 25, wherein the terminal is a cellular network enabled device and the data is received from the drone over a cellular network.

27. A vehicle comprising the lightbar of claims 1 to 17, and/or the drone of claims 18 to 23, or the system of claims 24 to 26.

28. The vehicle of claim 27 comprising a camera mounted on the vehicle, wherein the camera is separate to the lightbar and the drone.

29. The vehicle of claim 28 wherein the camera is mounted on the vehicle such that it faces in the direction opposite to the vehicle's normal direction of travel.

30. The vehicle of claim 27 or 29, comprising a user terminal configured to receive data from the drone.
